(19) United States
(12) Patent Application Publication
(10) Pub. No.: US 2012/0260842 A1
(43) Pub. Date: Oct. 18, 2012

(54) Vehicle flag

(76) Inventor: Douglas Moreland King, Mooresville, NC (US)

(21) Appl. No.: 13/066,241

(22) Filed: Apr. 14, 2011

(51) Int. Cl. G09F 17/00

(52) U.S. Cl. 116/174

(57) ABSTRACT

A non-flexible vehicle flag made molded plastic thin walled rigid material where a front half and a rear half are screwed together to form a hollow rectilinear shape having an aerodynamic teardrop shaped cross section. Horizontal ribs inside the hollow structure have cut out areas that retain bushings. The flag can rotate about a flag pole that is retained by the bushings. The flag pole can be attached by a bracket to the ledge of any standard vehicle window. The teardrop cross sectional shape allows the flag to cut through the air with minimal turbulence during use.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of decorative flags and more specifically to a rigid vehicle flag.

For many years there has been a tradition of mounting flags to vehicles so that the vehicle's owner can display his or her endorsement for a specific team, organization or person or location such as a city or a country. The flag is usually mounted onto the top edge of the vehicle's side window. Sometimes flags are mounted on both the left and the right side windows.

Typically, the flags are made of cloth or thin flexible plastic and have a specific graphic display printed on them. Numerous patents have been issued for vehicle flags. Some of them, such as U.S Pat. Nos. 2,398,748, 4,015,557 and 4,519,153—all now in the public domain—describe ways of attaching the flag to the window edge. One patent—U.S. Pat. No. 6,609,476—discloses a rigid flag that attaches to a vehicle antenna and is molded as a single piece of plastic.

However, there is a deficiency in the prior technology in that cloth flags or flags made out of other flexible materials tend to become ripped or shredded over a short period of use due to the strong wind forces generated as the vehicle is traveling at speeds as high as 70 miles per hour. The rigid flag described in U.S. Pat. No. 6,609,476 is quite small, but even so, would probably cause harmful flexing to the antenna that it is attached to. A larger version of this solid body design would be completely impractical for a window mounted display because of its excessive weight.

### BRIEF SUMMARY OF THE INVENTION

The primary object of the invention is to provide a non flexible flag that can attach to a vehicle's side window that has an aerodynamic cross section for efficient, non turbulent air flow when the vehicle is in motion.

Another object of the invention is to provide a non flexible flag for a vehicle that includes rotational bearing surfaces where the flag portion meets the flag pole portion.

Another object of the invention is to provide a non flexible flag for a vehicle that is constructed from rigid yet very light material.

A further object of the invention is to provide a non flexible flag for a vehicle that allows a decorative panel to be wrapped around the flag structure and to be protected from disengaging from the main flag structure.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a vehicle flag comprising: a rigid front flag half member, a rigid rear flag half member, a flag pole, a pair of bushings, a pole retaining cap, a pole receiving bracket, a flexible decorative panel and a plurality of flag half retaining screws. Said rigid flag members made of thin walled injection molded plastic, said rigid front flag half member and said rigid rear half member joined together by said retaining screws to form a hollow rectilinear structure whose cross section is an aerodynamic teardrop shape, said rigid front flag half member and said rigid rear half member having a plurality of internally molded in horizontally disposed structural ribs that include bushing retaining cutout areas, said bushings each including a top and bottom flange, said bushing flanges trapped by said horizontal ribs, said pole retaining cap fixedly attached to the top of said flag pole thereby preventing said pole from slipping through said bushings during use, said flag pole fixedly attached to said pole receiving bracket, said pole receiving bracket constructed of rigid material and including an inverted J shape that allows said bracket to be removably attached to the ledge of a vehicle window and said decorative panel including one side having adhesive material that allows said decorative panel that is fixedly attached to the front and rear surface of said rigid flag half members.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is an exploded perspective view of the invention.

FIG. 2 is a side view of the invention mounted to a vehicle.

FIG. 3 is a top perspective view of the invention mounted to a vehicle.

FIG. 4 is an exploded view of the display panel before it gets wrapped around the main flag body.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

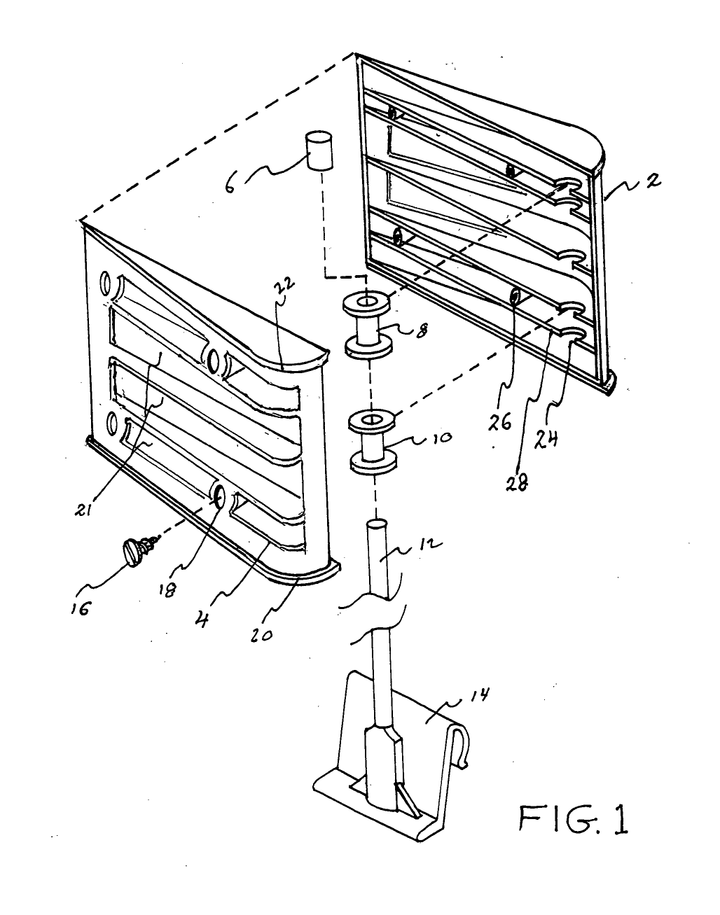

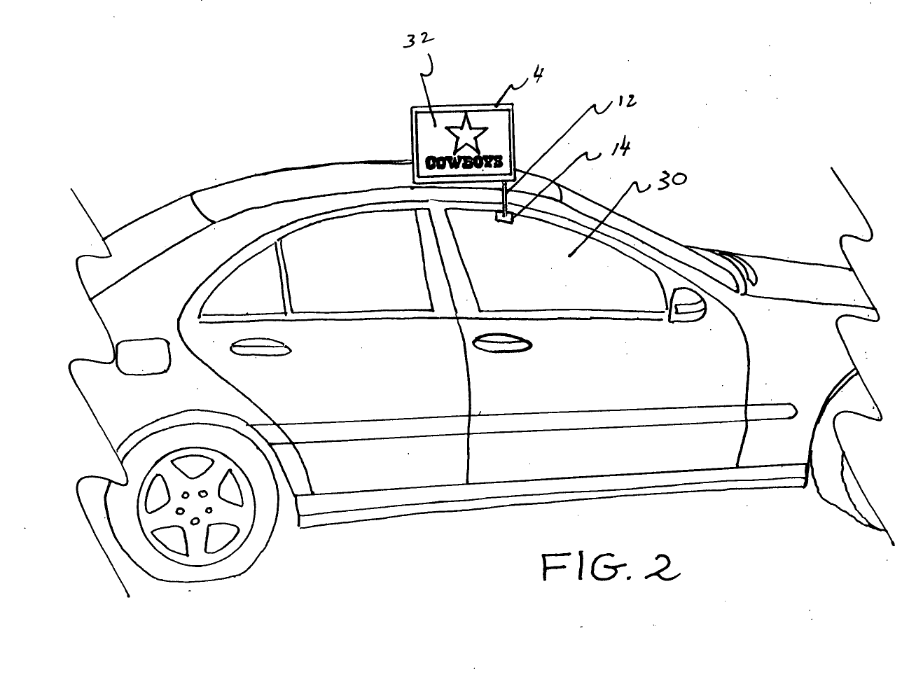

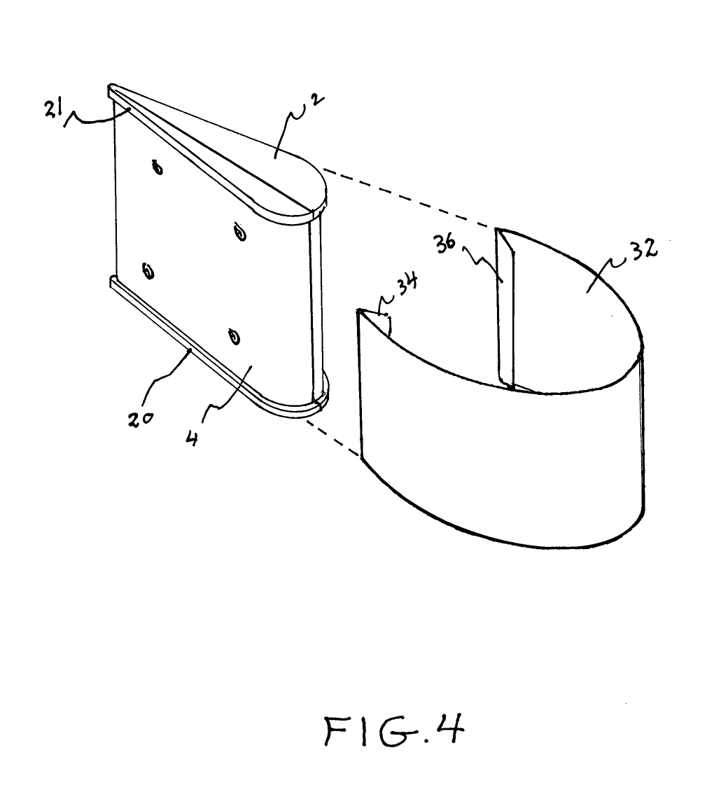

Referring now to FIG. 1 we see an exploded view of the non-flexible vehicle flag of the present invention. Front rigid flag half 4 and rear rigid flag half 2 are injection molded of rigid plastic such as polypropylene. The wall thickness of the molded parts 2, 4 is very thin, approximately thirty-five thousands of an inch, to create a relatively light weight flag structure. Cut out areas 21 further act to lighten the overall weight of the side walls 2, 4. Horizontal ribs 28 are molded into the structure of both halves 2, 4 to increase rigidity and structural integrity. Flag pole 12 is preferably made of a thin wall fiberglass tube for maximum strength and minimum weight. Cut out portions 24 allow for insertion of bushings 8, 10. The flanges on the bushings 8, 10 fit over the ribs to that they are held in place when the two halves 2, 4 are screwed together by screws 16 as they go through apertures 18 and into post holes 26. Pole cap 6 is fixedly attached to the top of pole 12 after the bushings 10, 12 are installed. This prevents the pole 12 from slipping out of the flag assembly 2, 4 during use. A slip fit is created between the flag pole 12 and the bushing so that the flag assembly 2, 4 can freely rotate about pole 12 during normal driving operation. When the two halves 2, 4 are joined they form a rectilinear hollow shape whose cross section is teardrop shaped so that it can slice through the air in a non turbulent fashion during use. Pole receiving bracket 14 is molded from rigid plastic such as ABS. The inverted J shape at the top of the bracket is designed to receive the top edge of a standard vehicle window. To install the bracket, the user places the inverted J portion onto the top edge of the window 30 and then raises the window 30 to trap the bracket 14 in place as shown in FIG. 2. Optionally, the flag pole 12 may be comprised of two elongate pieces that are joined by a standard adjustable angle connector so that the flag pole 12 can be adjusted to be in perpendicular relationship to the ground plane no mater what angle the bracket 14 is as it is pinned between the window ledge and the window frame. FIG. 4 shows the flag structure 2, 4 with a flexible decorative panel 32 ready to install onto the flag structure 2, 4. The outwardly protruding flanges 20, 21 on the flag structure 2,4 provide protection for the top and bottom edges of the decorative panel 32 after it is installed. Additionally, to prevent the trailing edges of the decorative panel from being degraded, the ends 34, 36 of the panel 32 extend beyond the length of the flag structure 2, 4 and are then folded over so that they can be trapped between the flag halves 2, 4 before the retaining screws 16 are fully locked down. With the trailing edges 34, 36 locked in place, the decorative panel 32 is forced to stay in position on flag structure 2, 4.

Alternately, the side walls 2, 4 can be made in a solid sheet with no lightening cutouts and a decorative design can be printed directly to the side walls of the flag structure 2, 4 thereby eliminating the need for a separate flexible panel.

In a second alternate embodiment, a shrink wrapped enclosure can be installed around side walls 2, 4 forming a singular all encompassing skin that is tightly surrounding the molded housing 2, 4.

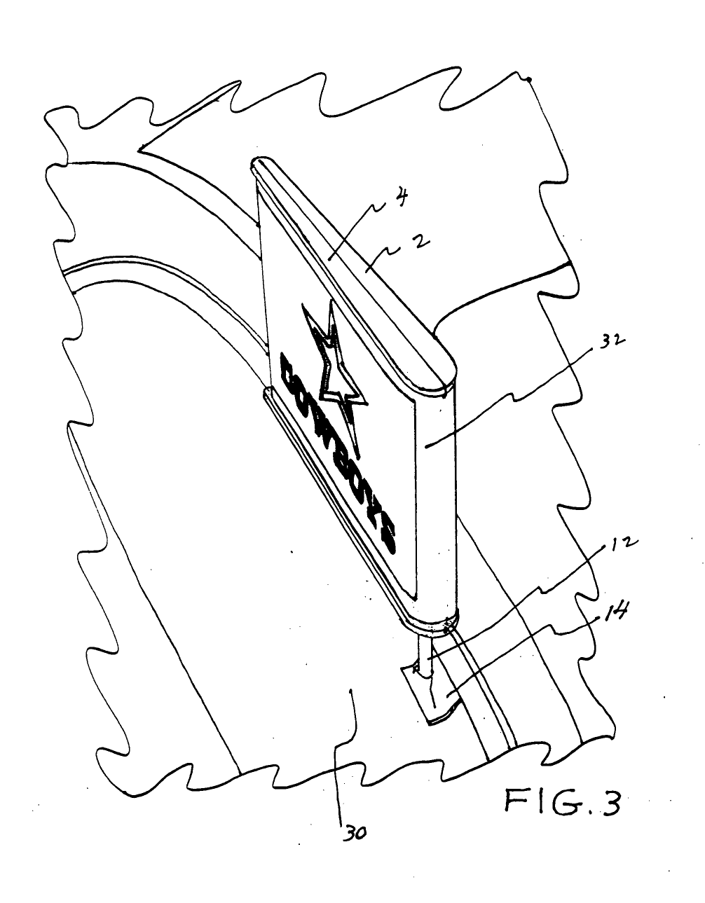

The top perspective view shown in FIG. 3 clearly shows the aerodynamic, teardrop shape of the flag structure 2, 4. This shape is ideal for slicing through air at high speeds, which regularly occur during vehicle travel. The light weight rigid flag shape 2, 4 and attached decorative panel 32 have much less of a tenancy to degrade over time and use as compared to a standard cloth type flag.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. vehicle flag comprising:
a rigid front flag half member;
a rigid rear flag half member;
a flag pole;
a pair of bushings;
a pole retaining cap;
a pole receiving bracket;
a flexible decoratively designed panel;
a plurality of flag half retaining screws;
said rigid flag members made of thin walled injection molded plastic;
said rigid front flag half member and said rigid rear half member joining together by said retaining screws to form a hollow rectilinear structure whose cross section is an aerodynamic teardrop shape;
said rigid front flag half member and said rigid rear half member having a plurality of internally molded in horizontally disposed structural ribs that include bushing retaining cutout areas;
said bushings each including a top and bottom flange;
said bushing flanges trapped by said horizontal ribs;
said flag pole slidably and rotatably retained within said bushings;
said pole retaining cap fixedly attached to the top of said flag pole thereby preventing said pole from slipping through said bushings during use;
said flag pole fixedly attached to said pole receiving bracket;
said pole receiving bracket constructed of rigid material and including an inverted J shape that allows said bracket to be removably attached to the top edge of a vehicle window and
said decoratively designed panel including one side having adhesive material that allows said decorative panel that is fixedly attached to the front and rear surface of said rigid flag half members.

2. A vehicle flag as claimed in claim 1 wherein said rigid flag half members terminate in top and bottom panels that each include an outwardly overhanging portion that protects the top and bottom edges of said decoratively designed panel.

3. A vehicle flag as claimed in claim 1 wherein said decoratively designed panel extends beyond the trailing edge of said rigid flag halves and is then folded onto the inner walls of said rigid flag halves before said flag halves are screwed together.

4. A vehicle flag as claimed in claim 1 wherein said flag pole is constructed of thin wall fiberglass material.

5. An alternate embodiment to the vehicle flag as claimed in claim 1 wherein said decorative design is printed directly onto the side walls of said flag structure without need of an additional flexible panel.
A second alternate embodiment of the vehicle flag as claimed in claim 1 wherein a shrink wrapped enclosure skin replaces the said decoratively designed panel.
